(19) United States
(12) Patent Application Publication
(10) Pub. No.: US 2013/0213240 A1
(43) Pub. Date: Aug. 22, 2013

(54) PORTABLE BREWING DEVICE

(71) Applicant: Espressi, Inc., (US)

(72) Inventors: Stephen James O'BRIEN, San Jose, CA (US); Najma KHAN, San Jose, CA (US)

(73) Assignee: Espressi, Inc., San Jose, CA (US)

(21) Appl. No.: 13/767,647

(22) Filed: Feb. 14, 2013

Related U.S. Application Data
(60) Provisional application No. 61/600,341, filed on Feb. 17, 2012.

(51) Int. Cl. A47J 31/38

(52) U.S. Cl. CPC A47J 31/38
USPC 99/297

(57) ABSTRACT

A beverage brewing system comprised of a brewing chamber and removable adaptors that enable a plurality of brewing styles using beverage filter cartridges and loose beverage mediums.

### CROSS-REFERENCE TO RELATED APPLICATIONS

This application claims the benefit of priority to U.S. Provisional Patent Application No. 61/600,341 filed on Feb. 17, 2012, entitled “Portable Brewing Device” which is incorporated herein by reference for all purposes.

### BACKGROUND OF THE INVENTION

The present invention is in the technical field of beverage brewing devices. More particularly, the present invention is in the technical field of beverage brewing devices that utilize beverage filter cartridges. Further, the present invention is in the technical field of brewing devices that utilize non-portioned beverage mediums such as loose-leaf tea and pre-ground coffee.

Beverage filter cartridges contain a pre-portioned measure of a beverage medium. Conventional brewing devices for beverage filter cartridges are mechanically complex and therefore expensive to manufacture and prone to failure. They are also designed to be used in place due to their reliance on mains electricity. The electricity is used to power one or more systems inside the brewing device including a water heater, water pump, control circuits, and the input and display interface. The water pump transports the heated water under pressure from the heating vessel where it is injected through one or more piercing units into the beverage filter cartridge. The heated water combines with the beverage medium in the beverage filter cartridge and is gradually expelled under pressure into an output vessel such as a cup.

Such brewing devices typically use a plethora of sensors, electronic circuits, customized integrated circuits, and electronic displays, to consistently and safely manage the electrical and mechanical elements of the device. An example of such a device is produced by Keurig, Inc. for use with “K-CUP” beverage filter cartridges.

Beverage filter cartridges provide a convenient experience for the consumer, removing the need to measure a portion of a beverage brewing medium for each prepared drink. However, if the consumer wishes to prepare a beverage with such cartridges in any location other than the one in which the brewing device is located they must either relocate the brewing device, or use a second brewing device. Further, they must ensure mains electricity is available at that location. This limits the number of available locations and the portability of the brewing system. Further, the mechanical complexity of the brewing devices and their size limits their portability and, therefore, the convenience with which the consumer may transport them.

Many people also enjoy consuming beverages prepared with methods other than using a beverage filter cartridge. There exists in the art a plethora of devices for brewing loose ground coffee and tea. Depending on the desired result, loose ground coffee can be brewed in a variety of ways from steeping in a coffee press, also known as a french press, to low pressure extractions through a moka pot that utilizes steam pressure. Loose leaf tea is most often brewed in a pot or directly in the cup. The tea leaves may be captured in a permanent or temporary perforated pouch or metal mesh, or strained by a filter as the tea is poured into the cup. In some circumstances no straining takes place as it is desired the tea leaves be present in the cup.

Some of these brewing methods have been in use for decades and in other cases hundreds if not thousands of years. The devices used in for each brewing process have developed independently and established a distinct functional identity that limits each brewing device to a single brewing method. For example, a moka pot cannot prepare coffee in the style of a coffee press.

This causes a disadvantage to the consumer whose taste is not limited to a single brewing method. For example, if they enjoy coffee from a coffee press, tea from a pot, moka espresso and the convenience and variety of beverages offered by beverage filter cartridges they will need to procure and store at least four different brewing devices. This can be expensive and also inconvenient due to the storage space required to keep these products in the home or office kitchen.

Further, the beverage filter cartridges used in different pre-portioned brewing systems only work with the system for which they were developed. This limits the consumer's choice for beverages that may be available in one type of filter cartridge but not for the cartridges produced for the brewing system they already own.

US Patent Publication No. 2006/0260471, which is herein incorporated by reference, describes a coffee or tea press using a removable cap to permit removal of the spent beverage medium. The invention only provides for brewing a single style of beverage and adapting it for use with beverage filter cartridges is non-obvious. US Patent Publication No. 2010/0162899, which is herein incorporated by reference, described a brewing system using a compressed gas source and pressure regulator.

### SUMMARY OF THE INVENTION

The present invention is a manually operated portable brewing device that can also be used within an brewing automated system. It uses replaceable adaptors to provides a plurality of brewing methods including those required by beverage filter cartridges, loose-leaf tea, and ground coffee. The adaptors also can change the style of beverage produced by concentrating or relaxing the extraction pressure.

### BRIEF DESCRIPTION OF THE DRAWINGS

FIG. 1 is a perspective view of the present invention in a manual plunger configuration.

FIG. 2 is a cross-section view of the present invention in a manual plunger configuration.

FIG. 3 is a cross-section view of the beverage cartridge filter adaptor.

FIG. 4 is a cross-section view of a filter adaptor.

FIG. 5 is a cross-section view of a pressure-multiplying filter adaptor.

FIG. 6 is a cross section view of the present invention in a configuration for frothing milk.

FIG. 7 is an embodiment of the invention utilizing a compressed gas source and controllable pressure regulator.

### DETAILED DESCRIPTION OF THE INVENTION

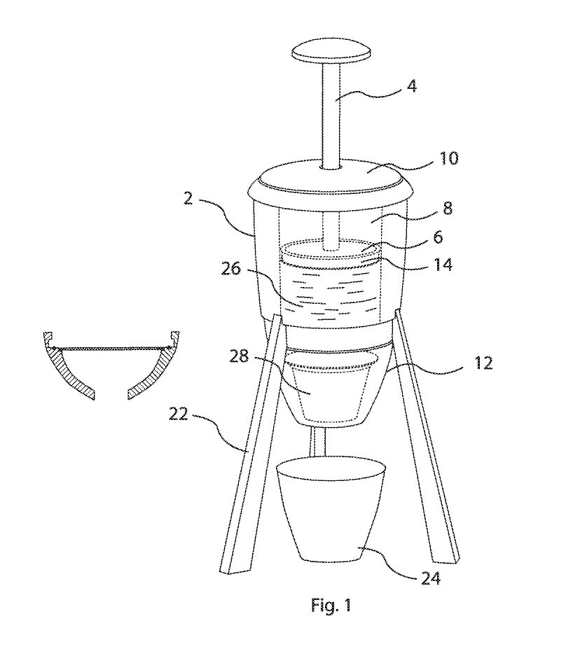

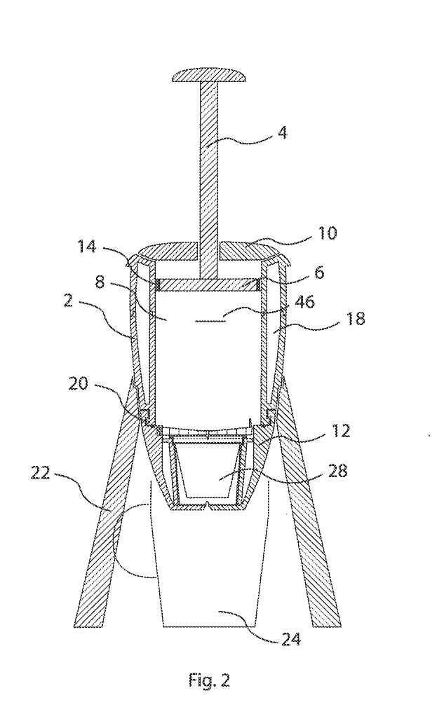

Referring now to the invention in more detail, in FIG. 1 and FIG. 2 there is shown a brewing device comprised of a brewing chamber wall 2, a plunger handle 4 attached permanently or temporarily to plunger base 6, a brewing chamber 8 containing heated water 26, a brewing chamber lid 10, and a cartridge brewing adaptor 12 containing a beverage filter cartridge 28. The entire assembly is elevated on a stand 22, with an output vessel 24 positioned to catch the outflowing beverage.

The brewing chamber is shown with a double-wall design that creates an insulating cavity 18 around the central chamber. insulating cavity 18 may optionally hold a partial vacuum to provide greater insulating properties.

Stand 22 holds the brewing chamber in position over an output vessel 24 such as a cup or other vessel the user desires to fill. Stand 22 may also be replaced by removable flange 54 allowing brewing chamber 8 and any brewing adaptor assemblies to be directly positioned over the top of an output vessel such that the flange rests on the upper rim of the vessel providing a stable platform.

In further detail, still referring to the invention of FIG. 1 and FIG. 2, the interior of brewing chamber 8 is a hollow cylinder with annular openings at the upper and lower ends. Plunger base 6 is constructed from a rigid material with an outer ring of a flexible material such as rubber, diametrically sized to form a hermetic seal with the inner wall of brewing chamber 8.

The construction details of the invention shown in FIG. 1 and FIG. 2 are that the invention's components may be made of plastic, metal or any other sufficiently rigid and strong material.

In more detail, referring now to FIG. 2, the present invention of FIG. 1 is shown in cross-sectional form. Brewing chamber wall 2 is shown in a double-wall configuration, providing brewing chamber wall cavity 18 from which air can be extracted during manufacture, creating a partial vacuum to provide temperature insulation properties. The brewing chamber may also be formed with a single wall. Plunger base 6 is encircled with an annular hermetic sealing piece 14, and is movable within brewing chamber 8 by means of plunger handle 4. Plunger base 6 may be permanently affixed to plunger handle 4, or affixed by a temporary means such that plunger handle 4 may be removed from plunger base 6 during normal operation.

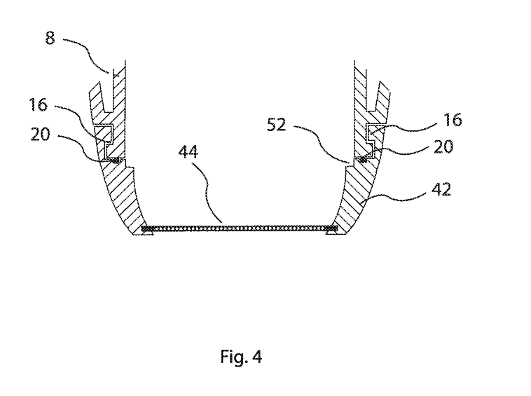

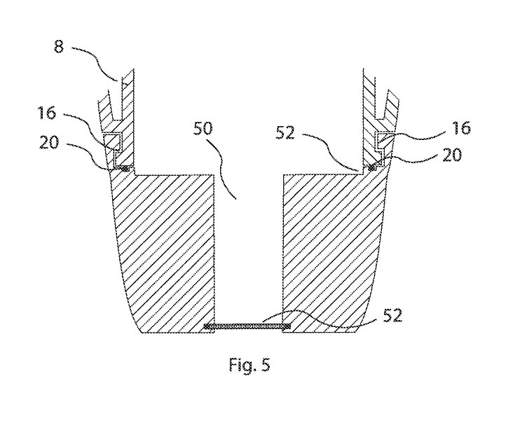

Cartridge brewing adaptor 12 is shown attached to the base of brewing chamber 8 by means of a bayonet mount, although any temporary attachment system may be used that provides a secure attachment. Beverage filter cartridge 28 is housed inside brewing adaptor 12 and supported by beverage cartridge support wall 40. It is an intention of this invention that cartridge brewing adaptor 12 may be exchanged for other brewing adaptors so designed to provide an optimal extraction of different types of beverages. Additional adaptors are shown in FIG. 4 and FIG. 5 and described below.

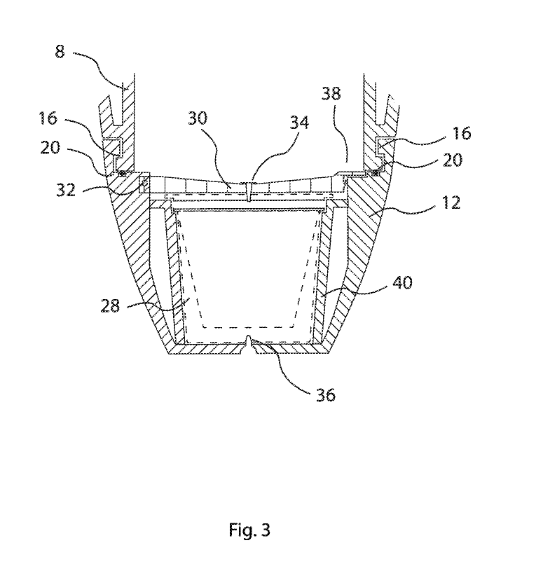

Referring now to FIG. 3, cartridge brewing adaptor 12 is attached to the base of brewing chamber 8 by means of bayonet mount 16. Annular o-ring 20, housed within a channel formed in the upper surface of beverage filter cartridge 28, provides an hermetic seal to prevent leakage of the brewing extraction liquid during the brewing process.

Beverage filter cartridge 28 is housed inside brewing adaptor 12 and supported by beverage cartridge support wall 40. Cartridge adaptor lid 30 rotates on hinge 32. When beverage filter cartridge 28 is not attached to bayonet mount 16, cartridge adaptor lid 30 may be lifted to enable insertion of beverage filter cartridge 28. When brewing adaptor 12 is then attached to bayonet mount 16, lever 38, an extension of cartridge adaptor lid 30, forces cartridge adaptor lid 30 to be positioned such that it is forced into direct contact with the upper surface of beverage filter cartridge 28. Piercing members 34 and 36 intersect with the upper and lower surfaces of beverage filter cartridge 28, piercing the upper and lower surfaces and thus creating a channel into and out of beverage filter cartridge 28 through which the brewing liquid may flow.

Referring now to FIG. 2 and FIG. 3, and more specifically when brewing chamber 8 is being used with brewing adaptor 12, during use brewing chamber lid 10, plunger handle 4 and plunger base 6 are removed from brewing chamber 8. Cartridge adaptor lid 30 is lifted by the user. Beverage filter cartridge 28 is placed in brewing adaptor 12 and the entire brewing adaptor 12 assembly is affixed to bayonet mount 8, forcing piercing members 34 and 36 to intersect with the respective surfaces of beverage filter cartridge 28.

Hot water is poured into the top of brewing chamber 8, filling the chamber no higher than maximum fill line 46. The assembly of brewing chamber lid 10, plunger handle 4 and plunger base 6 is positioned on top of brewing chamber 8. An air pocket is contained by hermetic seal 14 between the lower surface of plunger base 6 and the upper surface of the hot water.

Output vessel 24, or any vessel the user may select, is positioned under brewing adaptor 12. The user pushes down on plunger handle 4, forcing plunger base 6 to move down the inner wall of brewing chamber 8. The hermetic seal around plunger base 6 causes an increase in pressure within the part of the brewing chamber that is underneath plunger base 6. This pressure forces the hot water to enter beverage filter cartridge 28 through piercing member 3. The hot water mixes with the beverage medium already contained in beverage filter cartridge 28. As the user continues to push plunger base 6 down the brewing chamber the continuous pressure forces the now brewed contents of beverage filter cartridge 28 through piercing member 36 and into output vessel 24.

When the full volume of hot water has pushed through the air pocket formed beneath plunger base 6 will continue to through piercing member 34, beverage filter cartridge 28 and piercing member 36, drying the brewing medium contained within beverage filter cartridge 28 so the cartridge can be removed from brewing adaptor 12 with a minimum of mess.

When the brewing process has completed brewing adaptor 12 is removed from bayonet mount 16, cartridge adaptor lid 30 may be lifted and beverage filter cartridge 28 removed from brewing adaptor 12. Plunger base 6 may be pushed through the lower annular opening of brewing chamber 2 and removed from plunger handle 4, or it may be lifted by plunger handle 4 for removal through the upper annular opening of brewing chamber 2.

Referring now to FIG. 4, filter adaptor 42 is shown attached via bayonet mount 16 to brewing chamber 8. Filter adaptor 42 can be used for brewing ground coffee or loose-leaf tea, or many other types of granular beverage mediums.

Filter screen 44 is shown embedded in wall of filter adaptor 42. In different embodiments filter screen 44 may be located at any position along the vertical extent of filter adaptor 44. The beverage medium is placed by the user above filter screen 44. Filter screen 44 is a perforated screen made from metal or other suitable material with perforations of a diameter small enough to hold back the beverage medium, and to hold back the brewing liquid under normal weight due to surface tension from the liquid across the perforations in filter screen 44. The beverage medium is placed in the area above filter screen 44 and the brewing liquid such as hot water poured on top. The assembly of brewing chamber lid 10, plunger handle 4 and plunger base 6 is positioned on top of brewing chamber 8. The user waits for the desired length of brewing time to lapse and then pushes down on plunger handle 4, forcing plunger base 6 to move down the inner wall of brewing chamber 8. The pressure created by this action causes the brewed liquid to exit through filter screen 44, separating the beverage medium from the brewed liquid. Plunger base 6 reaches its limits of movement at plunger base stop 52, trapping the beverage medium within the interior of cavity of filter adaptor 42.

Referring now to FIG. 5, espresso adaptor 48 is shown attached via bayonet mount 16 to brewing chamber 8. The user fills beverage medium cavity 50 with the beverage medium. The beverage medium may be compressed into beverage medium cavity 50 by means of a tamper or similar devices, or be already compressed in a prepared removable, disposable container. In another embodiment the user may fill a removable basket.

The opening of beverage medium cavity 50 is sized to a diameter smaller than plunger base 6, increasing the pressure of the brewing liquid within beverage medium cavity 50, therefore increasing the extraction pressure from the beverage medium.

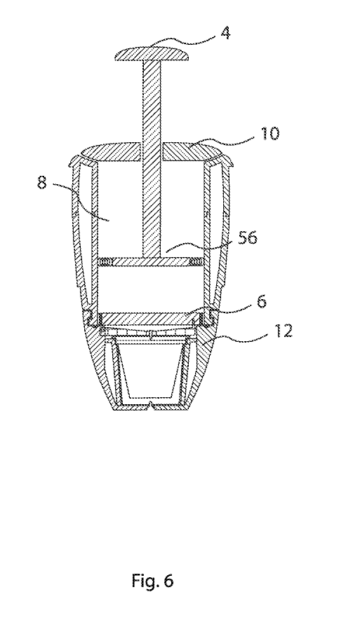

Referring now to FIG. 6, the invention is shown in an alternative configuration with cartridge brewing adaptor 12 attached, although this configuration could work with any adaptor designed to fit brewing chamber 8. A number of parts of the device previously disclosed have been removed from view for clarity. After the beverage is extracted with the usual brewing process, plunger base 6 is located at the bottom of the brewing chamber. In one embodiment plunger handle 4 may be temporarily attached to plunger base 6. There are many ways to achieve a temporary attachments including by use of a bayonet mount. Plunger base 6 continues to provide a water-tight seal at the bottom of the chamber. Plunger handle is then attached to frothing base 56. Milk frothing devices are well known in the art and can be created by various means including using a disk perforated by numerous holes and surrounded by a wire spiral. Hot milk is poured into the top of brewing chamber 8, and the assembly of plunger handle 4, brewing chamber lid 10 and frothing adaptor 56 inserted into the brewing chamber so that frothing adaptor 56 is immersed in the hot milk. A rapid vertical movement of plunger handle 4 moves frothing adaptor 56 through the milk, incorporating air into the milk causing it to froth. The frothing assembly can then be removed and the frothed milk used to complete the desired beverage.

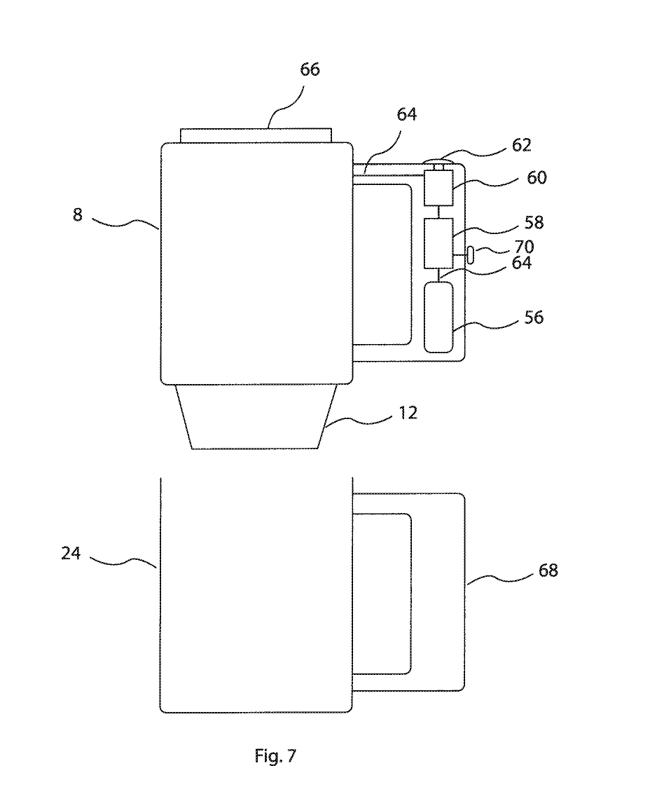

Referring now to FIG. 7, a further embodiment of the invention is shown utilizing a pressured gas source and pressure regulator described in US Patent Publication No. 2010/0162899, which is herein incorporated by reference. Compressed gas cartridge 56 provides pressure at p0 through pressure regulator 58 where it is reduced to output pressure p1 selected by regulator pressure control 70. A variable output pressure can be used to produce a wider range of beverages. The flow of gas is controlled by flow valve 60 and flow valve actuator 62. The gas flows through gas pipe 64 into brew chamber 8. A sealed brew chamber lid 66 allows the introduction of hot water. Cartridge brewing adaptor 12 and alternative adaptors described in this application may be attached to brewing chamber 8. The brewing system may also include an output vessel 24 and optional handle 68 designed to attach to brewing chamber 8 when not in use for convenient storage and portability.

There are a plurality of advantages to this invention that are not currently known to those of ordinary skill. The invention provides a convenient, non-electrical method for brewing beverages using beverage filter cartridges. The optional double-wall design minimizes heat loss during the brewing process. The use of adaptors enables the user to enjoy a plurality of brewing styles including but not limited to the three that are described herein, including beverage filter cartridges of varying shapes and size. Filter adaptor 42 minimizes the clean-up associated with brewing beverages using the coffee press or french press techniques as the beverage medium is conveniently collected within the adaptor after the brewing process is completed. The adaptor can then be removed from the bayonet mount and easily emptied into any other receptacle. Finally, espresso adaptor 48 enables brewing with higher extraction pressures than can be easily achieved by manual means.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed:

1. A brewing device, comprising:
a cylindrical brewing chamber;
one or more brewing adaptors that are temporarily connected to the lower portion of the brewing chamber and configured to receive water from the brewing vessel;
a plunger handle and base, the base being of sufficient diameter to hermetically seal against the inner wall of the brewing chamber.

2. The combination defined in claim 1 supported by a removable stand comprised of a plurality of legs extending down to a length sufficient to support the brewing device over a suitable output vessel.

3. The combination defined in claim 1 supported by a removable flange with a diameter sufficient to support the brewing device over a suitable output vessel.

4. The combination defined in claim 1 where the plunger handle and base are replaced by an hermetically sealed removable lid configured to provide fluid communication between a pressurized gas source and the brewing chamber.
